(19) United States
(12) Patent Application Publication
(10) Pub. No.: US 2024/0351343 A1
(43) Pub. Date: Oct. 24, 2024

(54) DEGASSING DEVICE AND INKJET RECORDING APPARATUS

(71) Applicant: KYOCERA Document Solutions Inc., Osaka (JP)

(72) Inventor: Hideki ISHIDA, Osaka (JP)

(73) Assignee: KYOCERA Document Solutions Inc., Osaka (JP)

(21) Appl. No.: 18/632,410

(22) Filed: Apr. 11, 2024

(30) Foreign Application Priority Data
Apr. 18, 2023 (JP) 2023-067919

(51) Int. Cl. B41J 2/19; B41J 2/175

(52) U.S. Cl. CPC B41J 2/19; B41J 2/17553; B41J 2/17556; B41J 2/17596

(57) ABSTRACT

A degassing device removes air dissolved in a liquid under a pressure decreased atmosphere, and includes a liquid tank, a circulation flow pass, a circulating device, a container, and a pressure decreasing device. The liquid tank stores the liquid. The circulation flow pass communicates different positions of the liquid tank. The circulation device circulates the liquid through the circulation flow pass. The container houses the circulation device. The pressure decreasing device decreases pressure in the liquid tank and the container.

### INCORPORATION BY REFERENCE

This application is based on and claims the benefit of priority from Japanese patent application No. 2023-067919 filed on Apr. 18, 2023, which is incorporated by reference in its entirety.

### BACKGROUND

The present disclosure relates to a degassing device and an inkjet recording apparatus.

In an inkjet recording apparatus, when an amount of dissolved gas of ink increases, bubbles may be generated inside a recording head, causing an ejection failure. Therefore, a technique for decreasing the amount of dissolved gas in ink has been studied. For example, there has been proposed a configuration in which ink in an ink tank is stirred under a state where pressure in the ink tank is decreased to degas the ink.

In the above degassing device, the ink in the ink tank is stirred, and the ink is degassed near the liquid surface. However, since the stirrer is located at the bottom of the ink tank, when an ink capacity increases, it becomes difficult to replace the ink near the liquid surface where the amount of dissolved gas is small with the ink near the bottom surface where the amount of dissolved gas is large, and degassing efficiency is lowered. In addition, the decreasing pressure may deteriorate performance of the degassing device.

### SUMMARY

A degassing device according to the present disclosure removes air dissolved in a liquid under a pressure decreased atmosphere, and includes a liquid tank, a circulation flow pass, a circulating device, a container, and a pressure decreasing device. The liquid tank stores the liquid. The circulation flow pass communicates different positions of the liquid tank. The circulation device circulates the liquid through the circulation flow pass. The container houses the circulation device. The pressure decreasing device decreases pressure in the liquid tank and the container.

An inkjet recording apparatus according to the present disclosure includes the degassing device and a recording head which ejects the liquid degassed by the degassing device.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a schematic view showing an inkjet recording apparatus according to one embodiment of the present disclosure.

FIG. 2 is a schematic view showing an ink supply mechanism according to the embodiment of the present disclosure.

FIG. 3 is a schematic view showing a degassing device according to the embodiment of the present disclosure.

FIG. 4 is a flowchart showing all operations of the degassing device according to the embodiment of the present disclosure.

FIG. 5 is a flowchart showing an operation in a pressure decreasing process of the degassing device according to the embodiment of the present disclosure.

FIG. 6 is a flowchart showing an operation in a degassing process of the degassing device according to the embodiment of the present disclosure.

FIG. 7 is a view showing a relationship between a pressure decreasing condition and a flow rate ratio.

FIG. 8 is a schematic view showing the ink supply mechanism according to a modified example of the embodiment of the present disclosure.

### DETAILED DESCRIPTION

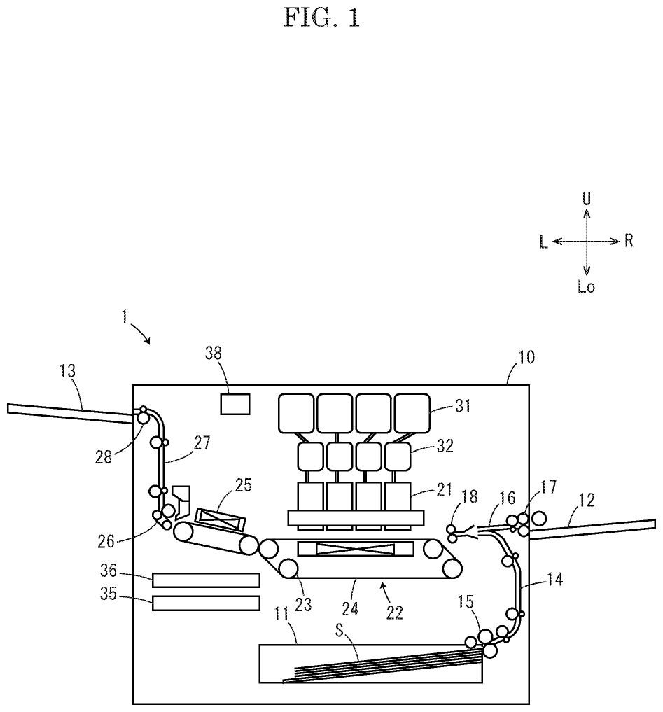

Hereinafter, with reference to the drawings, an inkjet recording apparatus 1 of the present embodiment will be described. FIG. 1 is a schematic view showing the inkjet recording apparatus 1 according to the present embodiment. For convenience of explanation, the front side of the paper surface on which FIG. 1 is drawn is defined as the front side of the inkjet recording apparatus 1, and the left-and-right direction will be described with reference to the direction in which the inkjet recording apparatus 1 is viewed from the front side. The arrows L, R, U, and Lo attached to each figure indicate the left, right, upper, and lower sides of the inkjet recording apparatus 1, respectively.

An inkjet recording apparatus 1 ejects ink from each inkjet recording head 21 toward a sheet S as a recording medium and performs printing. The inkjet recording apparatus 1 includes a box-shaped housing 10 in which various kinds of device are housed. In the lower portion of the housing 10, a sheet feeding cassette 11 in which the sheet S is set is housed, and a manual sheet feeding tray 12 on which the sheet S is set by hand is installed on the right side surface of the housing 10. On the upper portion of the left side surface of the housing 10, a sheet discharge tray 13 on which the recorded sheet S is stacked is installed.

In the right side portion in the housing 10, a first conveyance path 14 along which the sheet S is conveyed from the sheet feeding cassette 11 to the recording head 21 provided in the center of the housing 10 is formed. On the upstream side of the first conveyance path 14, a first sheet feeding part 15 which feeds the sheet S from the sheet bundle in the sheet feeding cassette 11 is provided, and a registration roller 18 which adjusts the feeding timing of the sheet S is provided in the downstream portion of the first conveyance path 14. Further, a sheet feeding path 16 of the manual sheet feeding tray 12 is merged with the downstream portion of the first conveyance path 14, and a second sheet feeding part 17 which feeds the sheet S from the sheet bundle on the manual sheet feeding tray 12 is provided on the sheet feeding path 16.

On the downstream side of the registration roller 18, a conveying device 22 and the recording head 21 provided for each color (for example, black, cyan, magenta, and yellow) are installed. The registration roller 18 corrects the skew of the sheet S and then sends the sheet S to the conveying device 22 in accordance with the ink ejecting operation by each recording head 21. In the housing 10, an ink container 31 and an ink tank 32 for each recording head 21 are container is provided. The ink of each ink 31 temporarily stored in the ink tank 32, the ink is degassed as necessary, and then the ink is supplied from the ink tank 32 to the recording head 21.

The conveying device 22 is constituted by winding a conveyance belt 24 around a plurality of tension rollers 23 installed below the recording heads 21. On the downstream side of the conveying device 22, a drying device 25 which dries the ink of the sheet S is provided. On the downstream side of the drying device 25, a decurl device 26 which corrects the curl generated on the sheet S by drying the ink is provided. On the downstream side of the decurl device 26, a second conveyance path 27 along which the sheet S is conveyed toward the sheet discharge tray 13 is formed. In the downstream portion of the second conveyance path 27, a sheet discharge part 28 which discharges the recorded sheet S to the sheet discharge tray 13 is provided.

Below the drying device 25, a maintenance unit 35 which cleans the recording heads 21 and a cap unit 36 which caps the recording heads 21 are provided. The maintenance unit 35 is provided with a squeegee-shaped wiping blade, and the wiping blade scrapes the ink remaining on the nozzle surface of the recording head 21. The cap unit 36 is provided with a head cap, and the nozzle surface of the recording head 21 is capped with the head cap. The head cap suppresses drying of the ink in the nozzle. The drying of the ink in the nozzle may be further suppressed by storing a liquid such as a cleaning liquid in the head cap.

Further, the inkjet recording apparatus 1 is provided with a control device 38 for controlling the entire apparatus. The control device 38 may be composed of a processor or a logic circuit (hardware) formed in an integrated circuit or the like. In the case of a processor, the processor reads and executes a program stored in a memory, and various processes are executed. For example, a CPU (Central Processing Unit) is used as the processor. The memory is constituted by one or more storage devices such as a ROM (Read Only Memory), a RAM (Random Access Memory) or the like depending on the application.

At the time of image recording, the sheet S is fed from the sheet feeding cassette 11 and the manual sheet feeding tray 12 by the first sheet feeding part 15 and the second sheet feeding part 17, respectively, and then sent to the registration roller 18. In accordance with the ejecting timing of the ink, the sheet S is conveyed from the registration roller 18 to the conveyance belt 24, the degassed ink is ejected from each recording head 21, and a color image is recorded on the surface of the sheet S. The sheet S is dried by the drying device 25, and the curl of the sheet S is corrected by the decurl device 26. The sheet S is conveyed to the sheet discharge part 28 through the second conveyance path 27, and the recorded sheet S is discharged to the sheet discharge tray 13 by the sheet discharge part 28.

By the way, the liquid surface of the ink touches the air in the ink tank 32, and the dissolving of the air proceeds, and the nozzle of the recording head 21 may be clogged by bubbles in the ink. Therefore, it is desired to appropriately keep an amount of dissolved gas in the ink. For example, a method has been proposed in which by passing the ink through the hollow fiver filter in a state where the pressure of the circumference of the hollow fiber filter is decreased, the air is moved from the wall surface of the hollow fiber to the pressure decreased side to degas the ink. This method requires the expensive hollow fiber filter and requires periodic replacement operations, which increase cost.

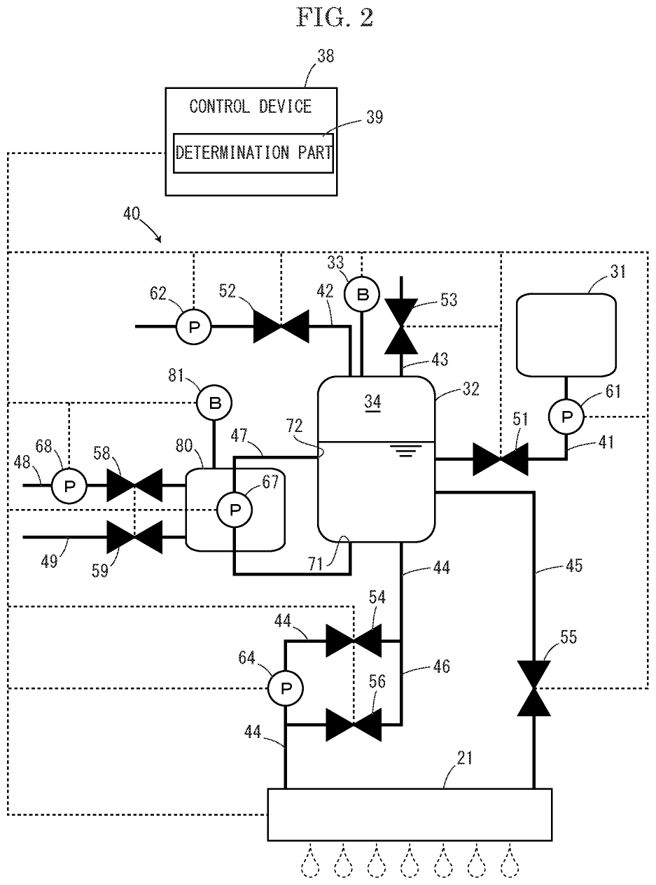

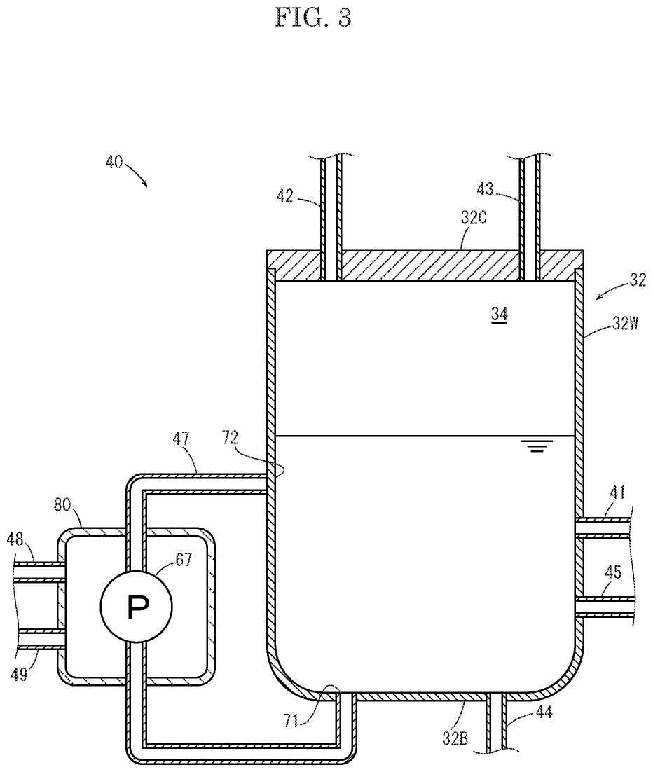

In order to prevent the clogging of the nozzle, a method (hereinafter referred to as the stirring degassing method) has been proposed in which the ink is stirred by the stirrer in a state in which the pressure in the ink tank 32 is decreased below an atmospheric pressure to degas the ink. In the stirring degassing system, a magnetic force is externally applied to the stirrer in the ink tank 32, and the stirrer is rotated by the magnetic force to stir the ink in the ink tank 32. When the depth of the ink and the tank diameter are large, the ink is difficult to be stirred, and the degassing efficiency is lowered. As the rotational speed of the stirrer is increased, the stirring becomes easier, but when the rotational speed of the stirrer becomes too high, a detuning phenomenon occurs and the rotational sound of the stirrer becomes large. Therefore, in the present embodiment, a circulating degassing method shown below is adopted.

[Degassing Device] FIG. 2 is a schematic view showing an ink supply mechanism according to the present embodiment. FIG. 3 is a cross-sectional view schematically showing a degassing device 40 according to the present embodiment. Although the inkjet recording apparatus 1 according to the present embodiment is provided with the ink supply mechanism for each color of the ink, one ink supply mechanism will be described here because these ink supply mechanisms have the same configuration.

[Ink Tank] The ink tank 32 has a cylindrical side wall portion 32W whose axial direction is along the upper-and-lower direction, a bottom portion 32B for closing the lower end portion of the side wall portion 32W, and a lid body portion 32C for closing the upper end portion of the side wall portion 32W. The horizontal cross section of the inner surface of the side wall portion 32W is preferably circular. Preferably, the side wall portion 32W and the bottom portion 32B are integrally formed.

[Replenishment Flow Pass] A replenishment flow pass 41 communicates with the ink container 31 and the ink tank 32. One end portion of the replenishment flow pass 41 is connected to the side wall portion 32W of the ink tank 32 at a position below the liquid level. On the replenishment flow pass 41, a replenishment pump 61 and a replenishment valve 51 are provided.

[Air Release Flow Pass] An air release flow pass 43 is connected to the lid body portion 32C and communicates with an upper space 34 of the ink tank 32. On the air release flow pass 43, an air release valve 53 is provided.

[Pressure Decreasing Flow Pass] A pressure decreasing flow pass 42 is connected to the lid body portion 32C and communicates with the upper space 34 of the ink tank 32. On the pressure decreasing flow pass 42, a pressure decreasing pump 62 and a pressure decreasing valve 52 are provided.

[Supply Flow Pass] A supply flow pass 44 communicates with the ink tank 32 and the recording head 21. One end portion of the supply flow pass 44 is connected to the bottom portion 32B of the ink tank 32. On the supply flow pass 44, a supply valve 54 and a supply pump 64 are provided.

[Recovery Flow Pass] A recovery flow pass 45 communicates with the ink tank 32 and the recording head 21. One end portion of the recovery flow pass 45 is connected to the side wall portion 32W of the ink tank 32. On the recovery flow pass 45, a recovery valve 55 is provided.

[Bypass Flow Pass] The supply flow pass 44 includes a bypass flow pass 46 bypassing the supply valve 54 and the supply pump 64. On the bypass flow pass 46, a bypass valve 56 is provided.

[Circulation Flow Pass] A circulation flow pass 47 communicates with the vicinity of the bottom surface and the vicinity of the liquid surface of the ink of the ink tank 32. The circulation flow pass 47 has an outlet port 71 through which the ink flows out from the ink tank 32 into the circulation flow pass 47, and an inlet port 72 through which the ink flows in from the circulation flow pass 47 into the ink tank 32. The outlet port 71 is connected to the bottom portion 32B of the ink tank 32, and the inlet port 72 is connected to the side wall portion 32W of the ink tank 32 at a position near the liquid surface. That is, the inlet port 72 is positioned higher than the outlet port 71. On the circulation flow pass 47, a circulation pump 67 is provided. The ink is circulated via the circulation flow pass 47 by the circulation pump 67.

[Circulation Pump] As a pump usable as the circulation pump 67, a non-capacity type pump such as a centrifugal pump, an oblique flow pump and an axial flow pump, a capacity type rotary pump such as a vane pump, a gear pump, a screw pump and a perista pump (tube pump), and a capacity type reciprocating pump such as a piston pump, a branger pump and a diaphragm pump are known. Among them, the non-capacity type pump, the rotary pump other than the perista pump, and the reciprocating pump other than the diaphragm pump have the advantage that they are hardly affected by the pressure decreasing when the pressure in the ink tank 32 is decreased. On the other hand, the perista pump and the diaphragm pump are easily affected by the pressure decreasing but have the advantage of being inexpensive. In this embodiment, the perista pump or the diaphragm pump is employed as the circulation pump 67. Countermeasures against the effect of the pressure decreasing will be described later.

In general, the recording head 21 may be included in the circulation flow pass 47 of the circulating degassing type, but in the present embodiment, the recording head 21 is not included in the circulation flow pass 47. That is, the circulation flow pass 47 is provided separately from the flow pass for supplying the ink to the recording head 21. Since the recording head 21 is not included in the circulation flow pass 47, a possibility that a meniscus formed in the nozzle of the recording head 21 is destroyed by the pressure decreasing at the degassing and the outside air enters the recording head 21 can be reduced.

[Control Device] The replenishment pump 61, the pressure decreasing pump 62, the supply pump 64, the circulation pump 67, the replenishment valve 51, the pressure decreasing valve 52, the air release valve 53, the supply valve 54, the recovery valve 55, and the bypass valve 56 are controlled by the control device 38. The control device 38 includes a determination part 39 which determines the necessity y of the degassing operation in accordance with a leaving time of the ink. When the determination part 39 determines that the degassing of the ink is unnecessary, the degassing operation is not performed. Even if the air is resolved by leaving the ink, the ink can be used without degassing within an allowable time.

[Barometer] The ink tank 32 is provided with a barometer 33 which measures the atmospheric pressure in the upper space 34 of the ink tank 32. The control device 38 acquires atmospheric pressure data from the barometer 33.

Next, the basic operation of the degassing device 40 will be described. Here, the standby state will be described as an initial state.

[Standby State] In the standby state, the replenishment valve 51, the pressure decreasing valve 52, and the supply valve 54 are closed, and the air release valve 53, the recovery valve 55, and the bypass valve 56 are opened. The ink is stored in the ink tank 32, the liquid surface touches the air in the upper space 34 opened to the atmosphere, and then the air is dissolved in the ink with the lapse of time.

In the standby state, the determination part 39 of the control device 38 determines whether the degassing is necessary. For example, the control device 38 is provided with a timer, and the leaving time of the ink is measured by the timer. An amount of dissolved gas of the ink can be estimated from one or more parameters such as an atmospheric pressure, a temperature of the ink, and an elapsed time from the last printing. Therefore, the determination part 39 stores conversion information indicating a correspondence relationship between each parameter and the amount of dissolved gas of the ink, and estimates the amount of dissolved gas of the ink based on each parameter. In addition, the determination part 39 stores conversion information indicating a correspondence relationship between the amount of dissolved gas of the ink and the allowable time, and the allowable time is set based on the amount of dissolved gas of the ink. The allowable time is a time during which the printing is allowed without degassing even if the ink is left. For the conversion information indicating the correspondence relationship between each parameter and the amount of dissolved gas of the ink and the conversion information indicating the correspondence relationship between the amount of dissolved gas of the ink and the allowable time, map data, a lookup table, a conversion equation, and the like are used. These map data, lookup table, and conversion equation are obtained experimentally, empirically, and theoretically in advance.

When the leaving time of the ink is within the allowable time, the determination part 39 determines that the degassing is unnecessary because an oxygen saturation degree is low. When the leaving time of the ink exceeds the allowable time, the determination part 39 determines that the degassing is necessary because the oxygen saturation degree is high. If the degassing is necessary, the control device 38 performs the following pressure decreasing process and the degassing process.

[Pressure Decreasing Process] In the pressure decreasing process, the control device 38 closes the replenishment valve 51, the air release valve 53, the supply valve 54, the recovery valve 55, and the bypass valve 56, opens the pressure decreasing valve 52, and drives the pressure decreasing pump 62. Then, the air is sucked out from the upper space 34 of the ink tank 32, and the upper space 34 is decreased in pressure. The control device 38 stops the pressure decreasing pump 62 when the atmospheric pressure in the upper space 34 indicated by the barometer 33 reaches a target value (for example, −50 [kPa]).

[Degassing Process] When the pressure decreasing process is completed, the control device 38 performs the degassing process. In the degassing process, the control device 38 closes the replenishment valve 51, the pressure decreasing valve 52, the air release valve 53, the supply valve 54, the recovery valve 55, and the bypass valve 56, and drives the circulation pump 67 for a predetermined time. When the circulation pump 67 is driven, the ink in the ink tank 32 circulates through the circulation flow pass 47. The ink near the bottom surface of the ink tank 32 where an amount of dissolved gas is large flows out into the circulation flow pass 47 through the outlet port 71, and the ink in the circulation flow pass 47 flows into the vicinity of the liquid surface in the ink tank 32 through the inlet port 72. The liquid surface of the ink is exposed to the decreased pressure atmosphere to remove the air dissolved in the ink near the liquid surface. By smoothly replacing the ink near the liquid surface where an amount of dissolved gas is small with the ink near the bottom surface where an amount of dissolved gas is large, the degassing efficiency is improved. In addition, unlike the stirring degassing type, the depth of the ink and the tank diameter are not affected, and the driving sound of the circulation pump 67 is more suppressed than the rotating sound of the stirrer, and the quietness is enhanced.

[Head Circulation Process] A head circulation process may be performed before or after the degassing process or may be performed at a unique timing. In the head circulation process, the control device 38 closes the replenishment valve 51, the pressure decreasing valve 52, and the bypass valve 56, opens the air release valve 53, the supply valve 54, and the recovery valve 55, and drives the supply pump 64. Then, the ink is supplied from the ink tank 32 to the recording head 21 through the supply flow pass 44, and the ink is recovered from the recording head 21 to the ink tank 32 through the recovery flow pass 45. By circulating the ink between the recording head 21 and the ink tank 32, the ink with increased viscosity in the recording head 21 is replaced and bubbles are removed from the recording head 21.

[Printing Process] During the printing operation by the recording head 21, the replenishment valve 51, the pressure decreasing valve 52, and the supply valve 54 are closed, and the air release valve 53, the bypass valve 56, and the recovery valve 55 are opened. That is, during the printing operation, the ink tank 32 is released to the atmosphere and has the atmospheric pressure. During the printing operation, the pressure in the ink tank 32 is not decreased such that substantial degassing does not occur. Every time when the ink is ejected from the recording head 21, the ink is supplied from the ink tank 32 to the recording head 21 through the bypass flow pass 46 and the recovery flow pass 45. In some cases, the ink is replenished in the middle of ink replacement operation, printing operation, or the like. During the ink replenishment operation, the replenishment valve 51 is opened and the replenishment pump 61 is driven. The ink is replenished from the ink container 31 to the ink tank 32 through the replenishment flow pass 41 by driving the replenishment pump 61.

FIG. 1 and the others are schematically drawn, and the recording head 21 is actually disposed above the ink tank 32. A negative pressure is applied to the ink in the recording head 21 by a head difference from the ink in the ink tank 32, and a meniscus is formed in the nozzle of the recording head 21 by the negative pressure. After the ink is ejected from the recording head 21, the surface tension of the ink acts to reduce the surface area of the meniscus, and the resulting negative pressure draws the reduced amount of the ink from the ink tank 32 into the recording head 21. The recovery valve 55 may be closed, and the ink may be supplied to the recording head 21 only from the bypass flow pass 46.

If the pressure in the ink tank 32 is decreased to the extent that substantial degassing occurs in a state where the recording head 21 and the ink tank 32 are connected, the meniscus of the nozzle may be destroyed. Even if the meniscus is not destroyed, there is a risk that the shape of the meniscus in the nozzle is changed compared with the case where the ink tank 32 is released to the atmosphere, and the ejecting characteristics of the ink is changed. In the present embodiment, since the pressure in the ink tank 32 is not decreased so as not to cause substantial degassing during the printing operation, the meniscus in the nozzle of the recording head 21 is not destroyed, and since its shape not is changed, the ejection characteristic is not changed.

As described above, when the perista pump or the diaphragm pump is adopted as the circulation pump 67, there is a problem that it is easily affected by the pressure decreasing.

For example, in the case of the perista pump, the flow pass in the perista pump includes a flexible tube made of silicone rubber or the like, and the liquid is fed by squeezing the tube with a plurality of rollers. When the pressure in the ink tank 32 is decreased by the pressure decreasing pump 62, the atmospheric pressure in the flow pass is lowered, and therefore, the flow pass may be narrowed and the circulation performance may be deteriorated.

In the case of the diaphragm pump, the flow pass in the diaphragm pump includes a flexible diaphragm made of silicone rubber or the like, and the liquid is fed by reciprocating the diaphragm by a swash plate or the like. When the pressure in the ink tank 32 is decreased by the pressure decreasing pump 62, the atmospheric pressure in the flow pass is lowered, and therefore, the flow pass may be narrowed and the circulation performance may be deteriorated.

Therefore, the degassing device 40 according to the present embodiment uses the following method to suppresses the deterioration of the circulation performance due to the pressure decreasing. The degassing device 40 according to the present embodiment removes the air dissolved in a liquid under a pressure decreased atmosphere, and includes the liquid tank (for example, the ink tank 32) in which the liquid is stored, the circulation flow pass 47 which communicates different positions of the liquid tank, the circulation device (for example, the circulation pump 67) which circulates the liquid through the circulation flow pass 47, a container 80 in which the circulation device is housed, and a pressure decreasing device which decreases the pressure in the liquid tank and in the container 80.

The pressure decreasing device includes a first pressure decreasing device (for example, the pressure decreasing pump 62) which decreases the pressure in the liquid tank and a second pressure decreasing device (for example, the pressure decreasing pump 68) which decreases the pressure in the container 80, and the second pressure decreasing device decreases the pressure in the container 80 in parallel with the decreasing the pressure in the liquid tank by the first pressure decreasing device.

Specifically, they will be described below. Since the ink tank 32, the circulation flow pass 47, the circulation pump 67, and the pressure decreasing pump 62 are as described above, the container 80 and the pressure decreasing pump 68 will be mainly described below.

[Container, Pressure Decreasing Pump] The container 80 houses the circulation pump 67. The container 80 may be of any shape, such as a rectangular shape or a cylindrical shape. The circulation flow pass 47 penetrates the container 80. The pressure decreasing flow pass 48 and the air release flow pass 49 are connected to the container 80. On the pressure decreasing flow pass 48, a pressure decreasing valve 58 and a pressure decreasing pump 68 are provided. On the air release flow pass 49, an air release valve 59 is provided. The container 80 is airtight. The container 80 is provided with a barometer 81 for measuring the atmospheric pressure in the container 80. The control device 38 acquires atmospheric pressure data from the barometer 81. The air release valve 59 is closed, the pressure decreasing valve 58 is opened, and the pressure decreasing pump 68 is driven to decrease the pressure in the container 80. By opening the air release valve 59, the inside of the container 80 is opened to the atmosphere.

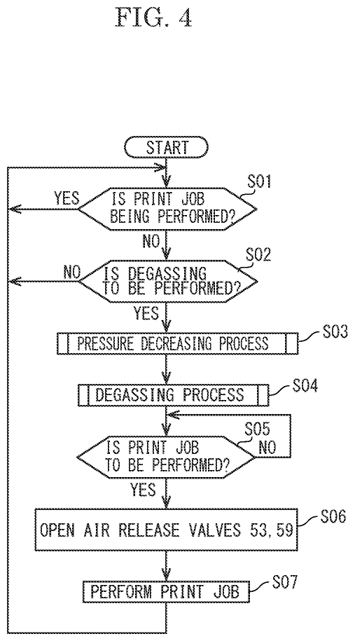

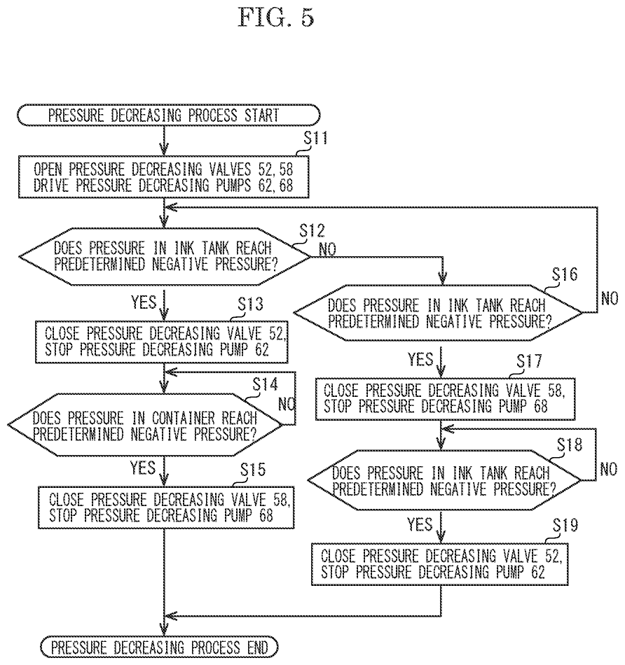

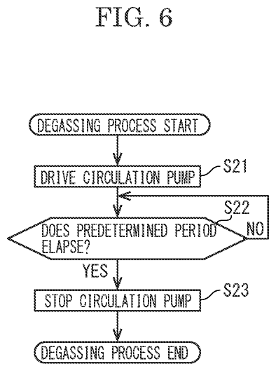

Next, the operation of the degassing device 40 will be described. FIG. 4 is a flowchart showing all operations of the degassing device 40. FIG. 5 is a flowchart showing the operation of the pressure decreasing process of the degassing device 40. FIG. 6 is a flowchart showing the operation of the degassing process of the degassing device 40.

Here, in the following description, the standby state is set as an initial state. In the standby state, the replenishment valve 51, the pressure decreasing valve 52, the supply valve 54, and the pressure decreasing valve 58 are closed, and the air release valve 53, the bypass valve 56, the recovery valve 55, and the air release valve 59 are opened. The ink is stored in the ink tank 32, and the liquid surface touches the air in the upper space 34 opened to the atmosphere, and then the air is dissolved in the ink with the lapse of time.

First, the control device 38 determines whether the print job is being performed (FIG. 4, step S01). When the print job is being performed (step S01: YES), the control device 38 repeats the determination in step S01. On the other hand, when the print job is not being performed (step S01: NO), the determination part 39 of the control device 38 determines whether the degassing is to be performed (step S02). For example, the control device 38 (see FIG. 2) is provided with a timer, and the leaving time of the ink is measured by the timer. An amount of dissolved gas of the ink can be estimated from one or more parameters such as an atmospheric pressure, a temperature of the ink, and an elapsed time from the last printing. Therefore, the determination part 39 stores conversion information indicating a correspondence relationship between each parameter and the amount of dissolved gas of the ink, and estimates the amount of dissolved gas of the ink based on each parameter. The determination part 39 stores conversion information indicating a correspondence relationship between the amount of dissolved gas of the ink and the allowable time, and the allowable time is set based on the amount of dissolved gas of the ink. The allowable time is the time during which the printing is allowed without degassing even if the ink is left.

When the leaving time of the ink is within the allowable time, since an oxygen saturation degree is low, the determination part 39 determines that the degassing is unnecessary and the degassing operation is not performed. When the leaving time of the ink exceeds the allowable time, since the oxygen saturation degree is high, the determination part 39 determines that the degassing is necessary, and the degassing operation is performed. For the conversion information indicating the correspondence relationship between each parameter and the amount of dissolved gas of the ink and the conversion information indicating the correspondence relationship between the amount of dissolved gas of the ink and the allowable time, map data, a lookup table, a conversion equation, and the like are used. These map data, lookup table, and conversion equation are obtained experimentally, empirically, and theoretically in advance.

When it is determined in step S02 that the degassing is not performed (step S02: NO), the control device 38 repeats the determination in step S01. On the other hand, when it is determined that the degassing is to be performed (step S02: YES), the control device 38 performs the pressure decreasing process (step S03, see FIG. 5).

Specifically, the control device 38 closes the replenishment valve 51, the air release valve 53, the supply valve 54, the recovery valve 55, the bypass valve 56, and the air release valve 59, opens the pressure decreasing valve 52 and the pressure decreasing valve 58, and drives the pressure decreasing pump 62 and the pressure decreasing pump 68 (step S11). Next, the control device 38 determines whether the atmospheric pressure in the ink tank 32 indicated by the barometer 33 reaches a predetermined negative pressure (step S12).

When it is determined that the atmospheric pressure in the ink tank 32 reaches the predetermined negative pressure (step S12: YES), the control device 38 closes the pressure decreasing valve 52 and stops the pressure decreasing pump 62 (step S13). Next, the control device 38 determines whether the atmospheric pressure in the container 80 indicated by the barometer 81 reaches a predetermined negative pressure (step S14). The predetermined negative pressure in step S14 is equal to the predetermined negative pressure in step S12. A predetermined negative pressure in steps S16 and S18, which will be described later, is also equal to the predetermined negative pressure in step S12. When it is determined that the atmospheric pressure in the container 80 does not reach the predetermined negative pressure (step S14: NO), the control device 38 repeats the determination in step S14. On the other hand, when it is determined that the atmospheric pressure in the container 80 reaches the predetermined negative pressure (step S14: YES), the control device 38 closes the pressure decreasing valve 58 and stops the pressure decreasing pump 68 (step S15).

On the other hand, when it is determined in step S12 that the atmospheric pressure in the ink tank 32 does not reach the predetermined negative pressure (step S12: NO), the control device 38 determines whether the atmospheric pressure in the container 80 reaches the predetermined negative pressure (step S16). When it is determined that the atmospheric pressure in the container 80 does not reach the predetermined negative pressure (step S16: NO), the control device 38 repeats the steps after step S12. On the other hand, when it is determined that the atmospheric pressure in the container 80 reaches the predetermined negative pressure (step S16: YES), the control device 38 closes the pressure decreasing valve 58 and stops the pressure decreasing pump 68 (step S17).

Next, the control device 38 determines whether the atmospheric pressure in the ink tank 32 indicated by the barometer 33 reaches the predetermined negative pressure (step S18). When it is determined that the atmospheric pressure in the ink tank 32 does not reach the predetermined negative pressure (step S18: NO), the control device 38 repeats the determination in step S18. On the other hand, when it is determined that the atmospheric pressure in the ink tank 32 reaches the predetermined negative pressure (step S18: YES), the control device 38 closes the pressure decreasing valve 52 and stops the pressure decreasing pump 62 (step S19).

Next, the control device 38 performs the degassing process (step S04 of FIG. 4, see FIG. 6). Specifically, the control device 38 drives the circulation pump 67 (step S21). When the circulation pump 67 is driven, the ink in the ink tank 32 is circulated through the circulation flow pass 47. The ink near the bottom surface of the ink tank 32 where an amount of dissolved gas is large flows out into the circulation flow pass 47 through the outlet port 71, and the ink in the circulation flow pass 47 flows into the vicinity of the liquid surface in the ink tank 32 through the inlet port 72. The liquid surface of the ink is exposed to the pressure decreased atmosphere to remove the air dissolved in the ink near the liquid surface. By smoothly replacing the ink near the liquid surface where an amount of dissolved gas is small with the ink near the bottom surface where an amount of dissolved gas is large, the degassing efficiency is improved. Since the pressure decreasing pump 62 and the pressure decreasing pump 68 are driven in step S11, the atmospheric pressure difference between the inside and the outside of the flow pass in the circulation pump 67 is suppressed, and the deterioration of the performance of the circulation pump 67 is suppressed.

Next, the control device 38 determines whether a predetermined time elapses since the start of driving the circulation pump 67 (step S22). When it is determined that the predetermined time does not elapse (step S22: NO), the control device 38 repeats the determination in step S22 while driving the circulation pump 67. On the other hand, when it is determined that the predetermined time elapses (step S22: YES), the control device 38 stops the circulation pump 67 (step S23). At the end of the degassing process, all valves are closed, so that the pressure decreased state is maintained.

Next, the control device 38 determines whether the print job is to be performed (step S05 in FIG. 4). When it is determined that the print job is not performed (step S05: NO), the control device 38 repeats the determination in step S05. On the other hand, when it is determined that the print job is to be performed (step S05: YES), the control device 38 opens the air release valve 53 and the air release valve 59 (step S06). Since the inside and the outside of the flow pass in the circulation pump 67 are opened to the atmosphere, the load applied to the flow pass in the circulation pump 67 is reduced. Next, the control device 38 performs the print job (step S07) and repeats the steps from step S01.

A relationship between the pressure decreasing of the ink tank 32 and the performance of the circulation pump 67 will now be described. As described above, when the pressure in the ink tank 32 is decreased under the atmospheric pressure, the flow pass is narrowed due to the atmospheric pressure difference between the inside and the outside of the flow pass in the circulation pump 67, and the circulation flow rate of the circulation pump 67 is lowered. Then, the pressure in the ink tank 32 is decreased under the atmospheric pressure, and the flow rate of a perista pump and a diaphragm pump are measured. The viscosity of the ink is set to 7 [mPa·s], the temperature of the ink is set to 25 [° C.], the tank diameter of the ink tank 32 is set to 60 [mm], and the depth of the ink is set to 28 [mm], and the pressure in the ink tank 32 is decreased from 0 to −80 kPa under the atmospheric pressure.

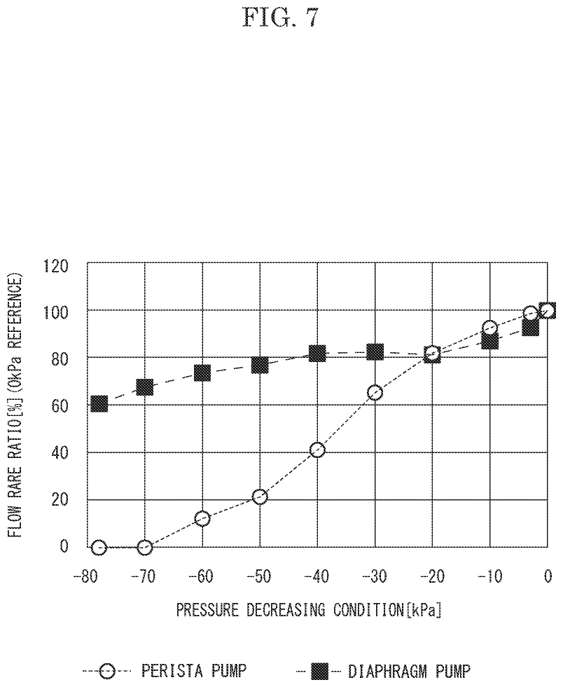

FIG. 7 is a view showing the relationship between the pressure decreasing condition and the flow rate ratio. The horizontal axis shows the pressure decreasing condition, that is the atmospheric pressure [kPa] of the ink tank 32, and the vertical axis shows the flow rate ratio [%]. The flow rate ratio is a ratio of the flow rate obtained by setting the flow rate of the circulation pump 67 when the pressure decreasing condition is 0 kPa to a reference (100%). The flow rate ratio is a numerical value that serves as an index of the performance of the circulation pump 67, and the closer the flow rate ratio is to 100%, the less the performance of the circulation pump 67 deteriorates.

From FIG. 7, in the case of a perista pump, a flow rate ratio of 60% or more is ensured when the pressure decreasing condition is from 0 to −30 kPa. On the other hand, in the case of a diaphragm pump, a flow rate ratio of 80% or more is ensured when the pressure decreasing condition is from 0 to −40 kPa. In addition, in many cases, the actual circulation pump 67 is designed so that the desired performance can be exhibited within 30 kPa of the inside and outside atmospheric pressure difference. As a result, if the atmospheric pressure difference between the inside and the outside of the circulation pump 67 is 30 kPa or less, the performance deterioration of the circulation pump 67 due to the pressure decreasing can be effectively suppressed. In the present embodiment, by decreasing the pressure in both the container 80 and the ink tank 32, a state in which the atmospheric pressure difference between the inside and the outside of the circulation pump 67 does not substantially occur can be realized, so that the effect of suppressing the performance deterioration of the circulation pump 67 due to the pressure decreasing can be maximized.

The degassing device 40 according to the present embodiment described above removes the air dissolved in the liquid under a pressure decreased atmosphere, and includes the liquid tank (for example, the ink tank 32) in which the liquid is stored, the circulation flow pass 47 which communicates different positions of the liquid tank, the circulation device (for example, the circulation pump 67) which circulates the liquid through the circulation flow pass 47, the container 80 in which the circulation device is housed, and the pressure decreasing device which decreases the pressure in the liquid tank and the container 80. According to this configuration, the atmospheric pressure difference between the inside and the outside of the flow pass in the circulation device is suppressed by decreasing the pressure of the inside and the outside of the flow pass, and therefore, the narrowing of the flow pass due to the pressure decreasing is suppressed. Therefore, it is possible to suppress the performance deterioration of the degassing device 40 due to the pressure decreasing.

The degassing device 40 according to the present embodiment includes the first pressure decreasing device (for example, the pressure decreasing pump 62) which decreases the pressure of the inside of the liquid tank and the second pressure decreasing device (for example, the container pressure decreasing pump 68) which decreases the pressure of the inside of the container 80, and the second pressure decreasing device decreases the pressure of the inside of the container 80 in parallel with the pressure decreasing of the inside of the liquid tank by the first pressure decreasing device. If the liquid tank and the container 80 are decreased in pressure at a different timing, narrowing or expansion occurs in the flow pass in the circulation device. If the narrowing and expansion of the flow pass are repeated over a long period of time, the members constituting the flow pass may deteriorate. According to the present embodiment, since the liquid tank and the container 80 are decreased in pressure in parallel, the narrowing and expansion of the flow pass in the circulation device hardly occur, and the deterioration of the member constituting the flow pass can be suppressed. In addition, the liquid tank and the container 80 can be decreased in pressure in a short time.

According to the degassing device 40 according to the present embodiment, the atmospheric pressure difference between the inside of the liquid tank decreased in pressure by the first pressure decreasing device and the inside of the container 80 decreased in pressure by the second pressure decreasing device is 30 kPa or less. According to this configuration, the performance deterioration of the circulation device can be suppressed.

According to the degassing device 40 according to the present embodiment, at least a part of the flow pass in the circulation device is made of flexible member. According to this configuration, the load applied on the flexible member forming the flow pass in the circulation device can be reduced.

According to the degassing device 40 according to the present embodiment, the circulation device is a perista pump or a diaphragm pump. According to this configuration, it is possible to reduce the load applied to the tube forming the flow pass in the perisa pump and the diaphragm forming the flow pass in the diaphragm pump.

The inkjet recording apparatus 1 according to the present embodiment is provided with the degassing device 40 and the recording head 21 which ejects the liquid degassed by the degassing device 40 to the sheet S. According to this configuration, the deterioration of image quality caused by the generation of bubbles can be suppressed.

The above embodiment may be modified as follows.

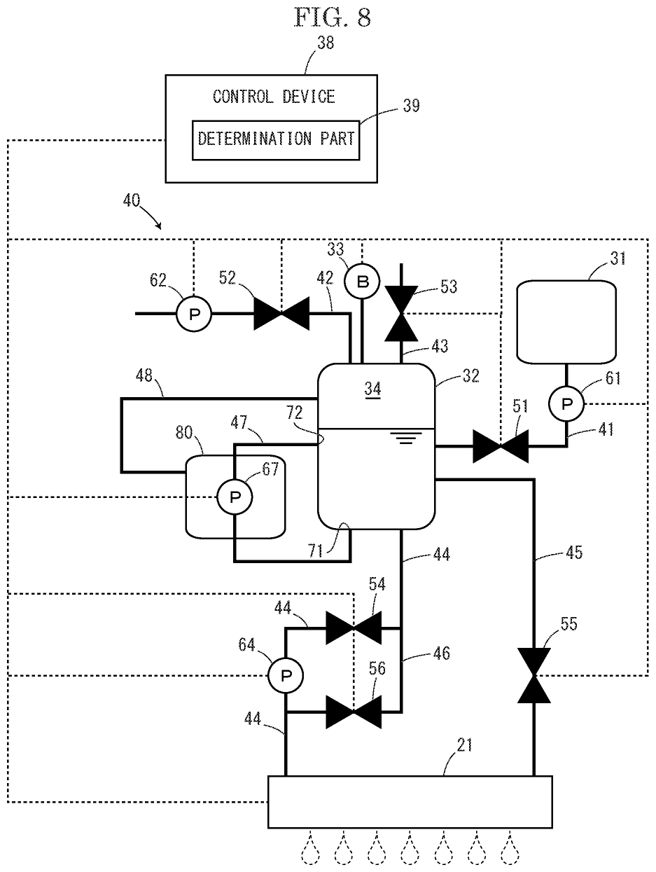

FIG. 8 is a schematic diagram showing the ink supply mechanism according to a modified example of the above embodiment. In this modified example, the container 80 communicates with the liquid tank (the ink tank 32), and the pressure decreasing device (the pressure decreasing pump 62) is connected to the liquid tank or the container 80. Specifically, the container 80 and the ink tank 32 communicate with each other through the pressure decreasing flow pass 48. When the pressure decreasing valve 52 is opened and the pressure decreasing pump 62 is driven, the pressure of the inside of the ink tank 32 and the inside of the container 80 are decreased in parallel. According to this modified example, since the liquid tank and the container 80 can be decreased in pressure by one pressure decreasing device, the cost can be reduced. Further, since the liquid tank and the container 80 are decreased in pressure to the same atmospheric pressure by one pressure decreasing device, the atmospheric pressure is easily controlled.

In the above embodiment, an example in which the degassing device 40 is provided in the inkjet recording apparatus 1 is shown, but the degassing device 40 can also be applied to a device used in other fields such as a semiconductor manufacturing field and a display manufacturing field. That is, it can be applied to degas chemical solution, electrolytic solution, liquid resin, adhesive, solvent, lubricating oil, liquid food, essence, and the like, other than the ink.

In the above embodiment, the pressure decreasing pump 62 and the pressure decreasing pump 68 are exemplified as the pressure decreasing device, but the pressure decreasing device may be a device capable of decreasing pressure in the ink tank 32, for example, the pressure decreasing device may be an ejector.

1. A degassing device which removes air dissolved in a liquid under a pressure decreased atmosphere, the degassing device comprising:
a liquid tank in which the liquid is stored;
a circulation flow pass which communicates different positions of the liquid tank;
a circulation device which circulates the liquid through the circulation flow pass;
a container in which the circulation device is housed; and
a pressure decreasing device which decreases pressure in the liquid tank and the container.

2. The degassing device according to claim 1, wherein
the pressure decreasing device includes:
a first pressure decreasing device which decreases a pressure of an inside of the liquid tank; and
a second pressure decreasing device which decreases a pressure of an inside of the container, and
the second pressure decreasing device decreases the pressure of the inside of the container in parallel with the pressure decreasing of the inside of the liquid tank by the first pressure decreasing device.

3. The degassing device according to claim 2, wherein
an atmospheric pressure difference between the inside of the liquid tank decreased in pressure by the first pressure decreasing device and the inside of the container decreased in pressure by the second pressure decreasing device is 30 kPa or less.

4. The degassing device according to claim 1, wherein
the container communicates with the liquid tank, and
the pressure decreasing device is connected to the liquid tank or the container.

5. The degassing device according to claim 1, wherein
at least a part of the flow pass in the circulation device is made of flexible member.

6. The degassing device according to claim 1, wherein
the circulation device is a perista pump or a diaphragm pump.

7. The degassing device according to claim 1, wherein
the circulation flow pass communicates with a vicinity of a bottom surface and a vicinity of a liquid surface of the liquid tank, and
an inlet port through which the liquid flows in from the circulation flow pass into the liquid tank is positioned higher than an outlet port through which the ink flows out from the liquid tank into the circulation flow pass.

8. An inkjet recording apparatus comprising:
the degassing device according to claim 1; and
a recording head which ejects the liquid degassed by the degassing device.

9. The inkjet recording apparatus according to claim 8, wherein
the liquid is ink, and
the degassing device degases the ink when a leaving time of the ink exceeds an allowable time.
